(19) United States
(12) Patent Application Publication
(10) Pub. No.: US 2008/0197721 A1
(43) Pub. Date: Aug. 21, 2008

(54) APPARATUS AND METHOD USING AN INDUCED MAGNETIC FIELD TO TURN A CRANKSHAFT IN AN ENGINE

(75) Inventor: GINA M. REYES, Iowa City, IA (US)

Correspondence Address: MCKEE, VOORHEES & SEASE, P.L.C., 801 GRAND AVENUE, SUITE 3200, DES MOINES, IA, 50309-2721, US

(73) Assignee: MAGMOTION, LLC, Iowa City, IA (US)

(21) Appl. No.: 12/035,049

(22) Filed: Feb. 21, 2008

Related U.S. Application Data
(60) Provisional application No. 60/902,358, filed on Feb. 21, 2007.

(51) Int. Cl. H02K 7/075; H02K 33/00

(52) U.S. Cl. 310/24; 318/119; 318/122

(57) ABSTRACT

The present invention is a method for modifying a current gas or diesel engine, or building a new one, which utilizes a magnetic field produced by solenoids in the cylinders or cylinder cover to exert force on a modified piston to turn a crankshaft. The present invention removes the need for fuel and eliminates emissions. The present invention utilizes the alternator in normal operation to provide the current through the solenoids to produce magnetic fields. Vehicle speed is controlled by changing the amount of current going through the solenoid. This process changes the magnitude of the originating and induced magnetic fields of the solenoid and piston. The operation of the vehicle remains similar to traditional operation, except the greatly beneficial aspects of not needing fuel or producing emissions.

### CROSS-REFERENCE TO RELATED APPLICATIONS

This application is a conversion of and claims priority to U.S. Provisional Patent Application No. 60/902,358 filed Feb. 21, 2007, which is herein incorporated by reference in its entirety.

### FIELD OF THE INVENTION

The present invention relates to gasoline and diesel engines. More particularly, the present invention modifies combustion engines by replacing the combustion mechanism for generating downward force on a piston with an induced magnetic field mechanism.

### BACKGROUND OF THE INVENTION

The idea of using a solenoid to induce a magnetic field on a piston is new and unique. The benefits of this invention are substantial. The present invention does not require the user to use any type of fuel or charge a battery in order for the vehicle to operate. The engine also produces no emissions.

Apparatuses and methods for generating a force on a piston to turn a crankshaft by combustion are ubiquitous. Generally, fuel/air mixture in the cylinder burns, the temperature rises and the fuel is converted to exhaust gas. This transformation causes the pressure in the cylinder to increase dramatically which forces the piston down. These apparatuses and methods require extreme dependence on oil, from which fuels are refined. They also produce emissions which are harmful to the environment and humans. The present invention eliminates the negative effects of dependence of fossil fuels, such as oil, using extensive battery systems, and producing harmful emissions. The present invention also does not reduce engine performance or convenience, which drivers are accustomed to.

Alternative engines such as hybrids rely in part on an electric motor to provide energy to turn the crankshaft. Hybrids also require an extensive battery system. These batteries need replacement generally within 6 years of use, at substantial cost to the owner. The other drawback to hybrid vehicles is that they still rely on gasoline or diesel, in conjunction with the electric motor, to operate. The present invention eliminates the need for an extensive battery system, fuel to operate and exhaust emissions.

Biodiesel vehicles utilize biodiesel fuel, which is a combination of diesel and biomaterials. While this technology is a great improvement over gas and diesel engines, it still requires the diesel component and as a result produces emissions.

What is needed is an efficient and effective method and apparatus for driving a piston to turn a crankshaft without combustion.

Therefore, it is a primary object, feature, or advantage of the present invention to improve over the state of the art.

It is a further object, feature, or advantage of the present invention to provide a non-combustion alternative for an existing combustion driven engine.

Another object, feature, or advantage of the present invention to provide solenoid induced magnetic field piston driving applications.

A still further object, feature, or advantage of the present invention to provide a solenoid wrapped cylinder wall to impart movement to a piston for driving a crankshaft.

Yet another object, feature, or advantage of the present invention is to provide a control associated with the electronics of an existing or new engine to manage current provided to a solenoid based on input from an accelerator or throttle.

A still further object, feature, or advantage of the present invention is to provide a solenoid positioned in an existing porthole into the cylinder to induce a current in the piston to repel the piston to drive the crankshaft.

Yet another object, feature, or advantage of the present invention is to provide a hollow core in a piston of an engine to pass a magnetic field from the solenoid through the core to induce a current in the piston for repelling the piston away from the solenoid.

A still further object, feature, or advantage of the present invention is to provide a solenoid positioned relative to a piston to expose the piston to magnetic flux from the solenoid to move the piston relative to the position of the solenoid.

These and/or other objects, features, or advantages of the present invention will become apparent. No single embodiment of the present invention need achieve all or any particular number of the foregoing objects, features, or advantages.

### BRIEF SUMMARY OF THE INVENTION

According to one aspect of the present invention a method for driving an engine without combustion is disclosed. The method includes providing an engine block with a plurality of cylinders formed by cylinder walls, a piston within each cylinder and a crankshaft connected to and driven by the piston, placing a solenoid relative to each piston, applying current to the solenoid to generate a magnetic flux, and moving the piston relative to the position of the solenoid with magnetic flux from the solenoid to drive the crankshaft.

In a preferred form, the method includes wrapping the solenoid around the cylinder wall at an optimum location to affect movement of the piston, pulling the piston toward a center location of the solenoid using magnetic flux from the solenoid to drive the crankshaft, pushing the piston away from the center location of the solenoid using magnetic flux from the solenoid to drive the crankshaft, connecting the solenoid to an electronic controller associated with the engine, controlling electrical current from the electrical system associated with the engine to the solenoid to increase or decrease rpm of the engine with the electronic controller, connecting the solenoid to a resistor element associated with an electrical system for operating the engine, applying current to the solenoid step includes applying current from a constant current source associated with the engine, programming an electronic controller associated with the engine to increase or decrease the rate of solenoid firing from the constant current source based on input from a throttle or accelerator associated with the engine, controlling timing and firing of solenoid in each piston with the electrical system for sequenced solenoid firing and ordered pushing and/or pulling on the crankshaft, and connecting the resistor element to a throttle or accelerator associated with the engine to change the current to the solenoid and rpm of the engine. The method may also include the piston having a ring with a hollow core, positioning the solenoid above the piston such that an applied magnetic field from the solenoid travels through the hollow core to produce an electrical current in the piston resulting in an induced magnetic field repelled by the applied magnetic field for driving the piston to turn the crank shaft, inserting the solenoid into a porthole in communication with the cylinder, passing an applied magnetic field from the solenoid through the hollow core to produce an electrical current in the piston resulting in an induced magnetic field repelled by the applied magnetic field for driving the piston downward to turn the crank shaft. According to another aspect of the present invention an engine driven without combustion is disclosed. The engine includes an engine block having a plurality of cylinders formed by cylinder walls, a piston in each cylinder, a crankshaft connected to and driven by the piston, a solenoid positioned relative to each piston, current from an electrical system associated with the engine applied to the solenoid to generate a magnetic flux, and the piston moved flux relative to the position of the solenoid by the magnetic to drive the crankshaft.

In a preferred form, the engine may also include the solenoid being wrapped around the cylinder wall at an optimum location to affect movement in the piston to drive the crankshaft, a resistor element is connected to the electrical system, and the resistor element adapted to control current from the electrical system to the solenoid to increase or decrease rpm of the engine wherein the resistor element is connected to a throttle or accelerator associated with the engine to change the current to the solenoid and rpm of the engine. The engine may also include the piston having a ring with a hollow core wherein the solenoid is positioned above the piston such that an applied magnetic field from the solenoid travels through the hollow core to produce an electrical current in the piston resulting in an induced magnetic field repelled by the applied magnetic field to drive the piston downward and turn the crankshaft. The engine may yet include a porthole in communication with the cylinder having a solenoid position therein and an applied magnetic field from the solenoid passes through the hollow core to produce an electrical current in the piston resulting in an induced magnetic field repelled by the applied magnetic field for driving the piston downward to turn the crankshaft wherein the porthole is a hole for a glow plug, a hole for a spark plug, a hole for an injector, a hold for a valve, or any hole providing access into the cylinder.

### BRIEF DESCRIPTION OF THE DRAWINGS

The following drawings form part of the present specification and are included to further demonstrate aspects of the present invention. The invention may be better understood by reference to one or more of the drawings in combination with the detailed description of specific embodiments presented therein.

FIG. 1 is an illustration of the magnetic field produced by a solenoid.

FIG. 2 is an illustration of Lenz's Law.

FIG. 3 is a perspective exploded view of a standard piston assembly.

FIG. 4 is a sectional perspective view of a standard combustion engine assembly.

FIG. 5 is a perspective view of a modified piston according to an exemplary embodiment of the present invention.

FIG. 6 is a perspective view of modified piston according to another exemplary embodiment of the present invention.

FIG. 7 is a perspective cross-sectional view of a modified engine assembly according to an exemplary embodiment of the present invention.

FIG. 8 is a perspective cross-section of a modified engine assembly according to another exemplary embodiment of the present invention.

### DETAILED DESCRIPTION OF THE PREFERRED EMBODIMENTS

The present invention is directed towards an apparatus and related methods for using an induced magnetic field for turning a crankshaft of an engine.

### Apparatus

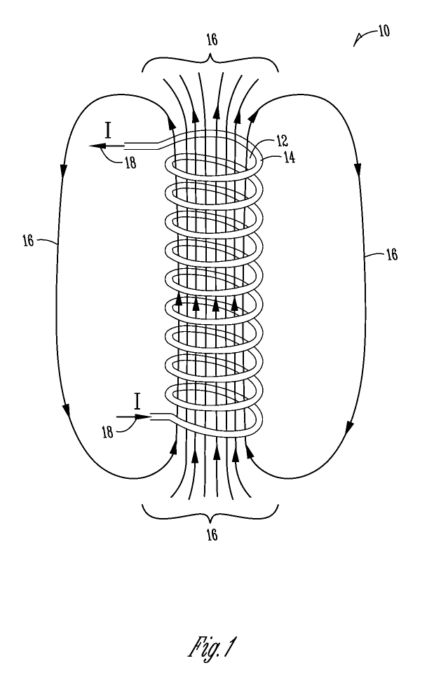

FIG. 1 shows a solenoid 10 as are known by those skilled in the art and commercially available. Solenoids can take the form of either an air core or iron core depending on the preferred application. FIG. 1 illustrates an air core solenoid. Core 12 of solenoid 10 is formed by windings 14. Those skilled in the art can appreciate the numerous types of materials available for use as windings 14. Suffice it to say, solenoid 10 may use any number of electrically conductive wire as windings 14. An applied current 18 to windings 14 creates an applied magnetic field 16 concentrated into a nearly uniform field in the center of core 12 of solenoid 10. In most cases, the applied magnetic field 16 outside core 12 of solenoid 10 is generally weaker and divergent from the stronger applied magnetic field 16 within core 12 of solenoid 10. The magnitude of the applied magnetic field 16 depends on applied current 18 through solenoid 10 and the number of windings 14 per unit length of solenoid 10. Therefore, adjustments to the number of windings 14 and applied current 18 increases the strength of the applied magnetic field 16 of solenoid 10.

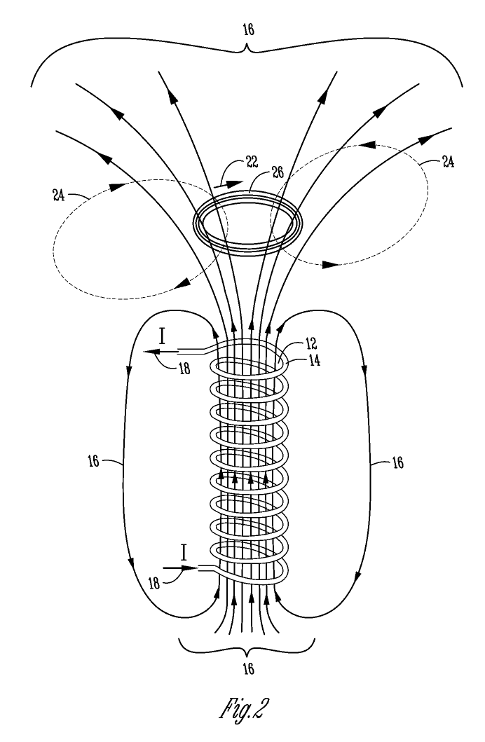

FIG. 2 illustrates generally the concept and teachings of Lenz's Law. Lenz's Law states generally that an induced electromotive force generates a current that induces a counter magnetic field that opposes the magnetic field generating the current. Basically, the direction of the induced current is such that the induced magnetic field always opposes the change in the flux. For example, solenoid 10, when current 18 is applied to windings 14, produces an applied magnetic field 16 that has field lines 20 (also known as magnetic flux) which are representative of the magnetic influence of solenoid 10. As ring 26, which is a conducting ring, approaches the field of influence or field lines 20 of solenoid 10, a current 22 is induced within ring 26, which in-turn creates an induced magnetic field 24 about ring 26. Moving solenoid 10 into close proximity to ring 26 causes induced current 22 to travel in a clockwise direction by operation of the right hand rule. The clockwise induced current flow 22 within ring 26 causes the induced magnetic field 24 to travel in a direction so as to oppose the change in the applied magnetic field 16 resulting from movement of solenoid 10. Thus, by application of Lenz's Law, the applied current 18 in solenoid 10 creates an applied magnetic field 16 that induces a counter magnetic field or induced magnetic field 24 that opposes the applied magnetic field 16 generating induced current 22. Simply put, when windings 14 of the solenoid 10 see applied current 18, applied magnetic field 16 results which in turn pushes ring 26 away from solenoid 10. Using one or more principles of electricity and magnetism, including but not with limitation Lenz's Law, the present invention seeks to provide apparatuses and methods for driving an engine without combustion using a resulting magnetic field to turn a crankshaft of an engine.

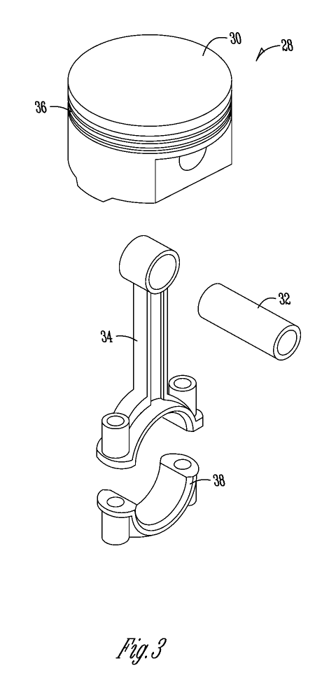

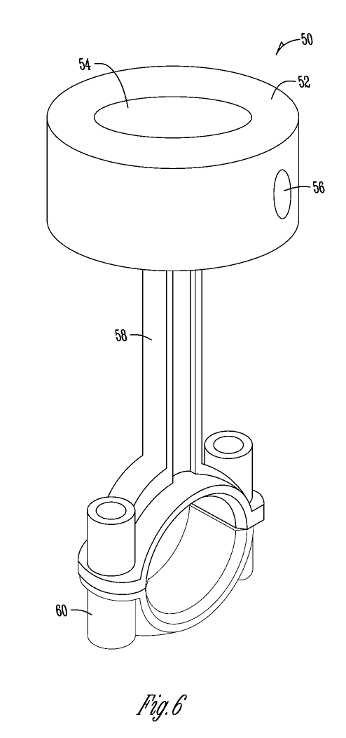

FIG. 3 illustrates a standard piston assembly 28 which are commercially available and well known to those in the art. Piston assembly 28 includes piston 30 which has a number of rings 36 disposed about the outer circumference. Piston pin 32 connects connecting rod 34 to piston 30. Rod cap 38 attaches connecting rod 34 to a crankshaft, like crankshaft 76 shown in FIGS. 6-8. Generally speaking piston 30 is driven downward by combustion to transfer energy from the moving piston through connecting rod 34 to drive crankshaft 36. The present invention seeks to obviate the need for combustion to drive piston 30 to transfer energy from piston 30 to connecting rod 34 and crankshaft 76.

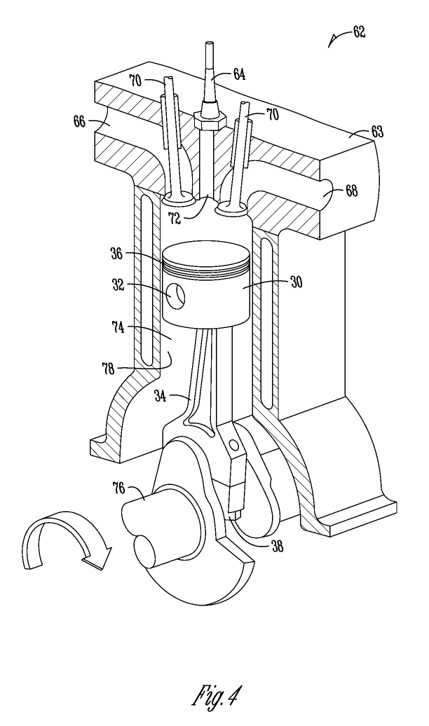

FIG. 4 illustrates a standard engine assembly 62 as are commercially available and well known to those skilled in the art. Standard engine assembly 62 operates using standard piston assembly 28 shown in FIG. 3. A standard engine assembly like standard engine assembly 62 shown in FIG. 4 includes an engine block 63. Engine block 63 is configured to form a cylinder 74 from cylinder wall 78 for housing standard piston assembly 28. Piston assembly 28, as described earlier with regard to FIG. 3, drives crankshaft 76. Thus, as piston 30 moves up and down within cylinder 74, the same movement is transferred through connecting rod 34 to crankshaft 76 to rotate crankshaft 76. In addition to including cylinder 74, standard engine assembly 62 also includes intake 66 and exhaust 68 ports for communicating non-combusted materials into cylinder 74 and combusted materials out of cylinder 74. The intake and exhausting of combusted and non-combusted materials is controlled by valves 70. The change in pressure within cylinder 74 resulting from combustion is sealed between valve 70 and the uppermost part of piston 30 using rings 36. An igniter 64 passes through porthole 72 in communication with cylinder 74. The igniter 64 may include a glow plug or a spark plug depending upon the type of engine. Thus, combustible material is brought into cylinder 74 through intake port 66, compressed by piston 30 and ignited by igniter 64 to drive piston 30 downward to turn crankshaft 76. Combusted material is then exhausted from cylinder 74 through exhaust port 68 by release of valve 70. Thus, the standard engine assembly 62 is dependent upon combustion to drive cylinder 74 and transfer energy from cylinder 74 to crank shaft 76. The present invention seeks to provide methods and apparatuses to obviate the need for combustion for driving crankshaft 76. In fact, the present invention replaces the combustion mechanism described and occurring in standard engine assembly 62 for generating downward force on piston 30 with a magnetic field mechanism according to an exemplary aspect of the present invention.

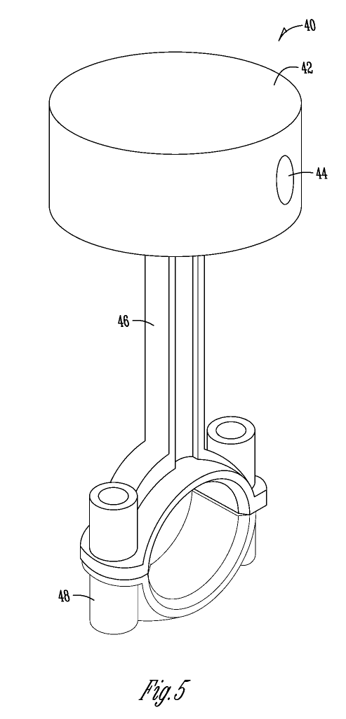

FIGS. 5 and 6 illustrate two exemplary embodiments of modified piston 42 and 52 respectively. Similar to the standard piston assembly 28 shown in FIG. 3, piston assembly 40 shown in FIG. 5 includes a piston pin 44 for attaching connecting rod 46 to modified piston 42. Connecting rod 46 is adapted to attach to crankshaft 76 using rod cap 48. Modified piston 42 may or may not include rings, such as rings 36 shown in FIG. 3. Those skilled in the art can appreciate that modified piston 42 need not necessarily have rings 36 if combustion is not being used to drive modified piston 42. However, rings 36 may be used to facilitate lubrication of cylinder 74. Thus, modified piston 42 need not but may have some of the same characteristics associated with piston 30 of standard combustion piston assembly 28 shown in FIG. 3. For example, modified piston 42 could be shorter than standard piston 30 shown in FIG. 3. Preferably, modified piston 42 is constructed of material that would respond to a resulting magnetic field emanating from one or more solenoid types, such as solenoid 10 shown in FIGS. 1 and 2. Generally speaking, modified piston 42 is configured in a manner that best suits driving piston 42 using a magnetic field 16 from a solenoid as opposed to being configured to be best driven by combustion. For example, as stated earlier, modified piston 42 may be configured with a smaller body to maximize the travel of piston, stroke or torque using a magnetic field from the solenoid 10.

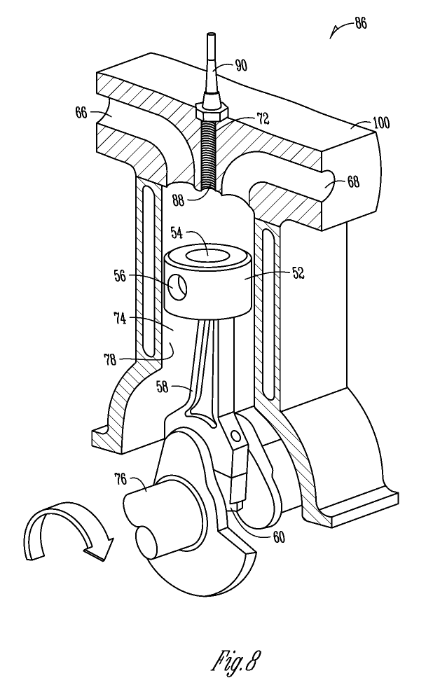

FIG. 6 illustrates another exemplary embodiment of a piston assembly 50 having a modified piston 52. Modified piston 52, like modified piston 42 shown in FIG. 5, is configured to operate by influence of solenoid windings 88 and solenoid plug 90 shown in modified engine block 84 of FIG. 8. Modified piston 52 of piston assembly 50 includes a hollow core 54. The hollow core 54 of modified piston 52 forms a hollow ring for passing the magnetic field resulting from solenoid plug 90 and solenoid windings 88 therethrough (similarly shown in FIG. 2). The hollow core 54 passes through the entirety of the body of modified piston 52. The modified piston 52 is connected to connecting rod 58 with piston pin 56 and to crankshaft 76 using the rod cap 60 as are well known in the art. The piston 52 face has a hollow core 54 in order to induce current in an orderly manner, if not, eddy currents would result in interference of the magnetic field and a reduction in power available from the magnetic field.

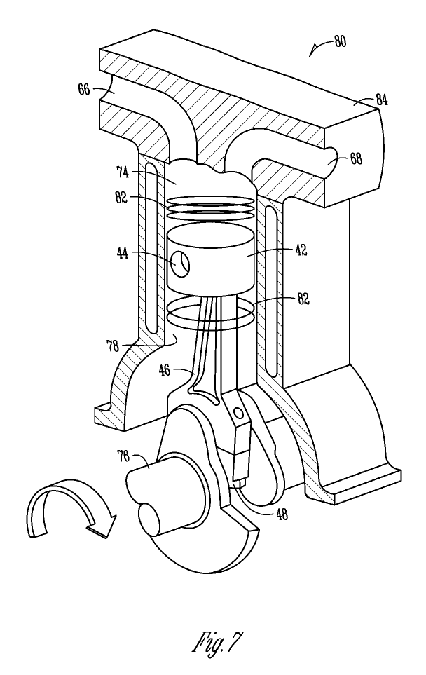

FIG. 7 illustrates exemplary embodiments of the methods and apparatuses of the present invention. FIG. 7 modifies the standard engine assembly 62 shown in FIG. 4. FIG. 7 shows standard engine assembly 62 shown in FIG. 4 having been modified and now including solenoid 82. Preferably, solenoid 82 is wrapped around cylinder wall 78 of cylinder 74. Current may be provided to solenoid 82 within cylinder 74 using an electrical system associated with the existing standard engine assembly 62. For example, solenoid 82 could be electrically fed by an existing distributor system associated with the standard engine assembly 62 used to send voltage through igniter 64. Those skilled in the art can appreciate that solenoid 82 can be wound such that the desired magnetic field results to move modified piston 42 within cylinder 74. An applied magnetic field results by providing current to solenoid 82. The applied magnetic field resulting from the applied current to solenoid 82 can be configured to pull modified piston 42 toward the center position of solenoid 82. Pulling piston 42 connected to crankshaft 76 toward center of solenoid 82 turns crankshaft 76. Those skilled in the art can appreciate the resulting advantage of reconfiguring piston 30 to a modified piston, such as modified piston 42 shown in FIG. 4. For example, by reducing the height of modified piston 42 increases the stroke of the modified piston assembly 40. By adjusting the number of windings and the applied current to solenoid 82, the desired power output of the modified engine assembly 80 can be controlled. For example, increasing the applied current to solenoid 82 by way of a throttle or accelerator associated with the standard engine assembly 62 allows modified engine assembly 80 power output and rpm to be controlled. The applied magnetic field resulting from solenoid 82 immediately collapses to zero, and the force applied to the modified piston 42 is removed when current is removed from the solenoid 82 by way of a control means, such as a throttle or accelerator. The present invention contemplates numerous concepts for controlling the current applied to solenoid 82 for driving the crankshaft 76. For example, a resistor element (not shown) associated with or integrated into the existing engine assembly 62, by operation or connection to a throttle or accelerator, may be used to control the amount of current being applied to solenoid 82 and thus resulting in a change in the force applied to modified piston 42 from the applied magnetic field emanating from the solenoid 82. In this manner, rpm of the modified engine assembly 80 may be increased or decreased using an existing throttle or accelerator associated with the standard engine assembly 62.

FIG. 8 illustrates modified piston 52 configured into modified engine assembly 86. Modified engine assembly 86 includes a modified engine block 100. Modified engine block 100 has a porthole 72 for keeping igniter 64 in communication with cylinder 74, as is customary with a standard engine assembly. The existing porthole 72 is used to house solenoid windings 88 attached to solenoid plug 90. The resulting magnetic flux from solenoid windings 88 passes through the hollow core 54 of modified piston 52. The flux or applied magnetic field from solenoid windings 88 traveling through the hollow core 54 of modified piston 52 produces a current in the modified piston 52 which results in an induced magnetic field opposing the applied magnetic field from solenoid windings 88. The applied magnetic field repels the induced magnetic field from modified piston 52 and thereby pushes the modified piston downward which rotates crankshaft 76. Similar to modified engine assembly 80 in FIG. 7, the applied magnetic field resulting from the solenoid windings 88 collapses and goes to zero when the current to the solenoid windings 88 is removed. Those skilled in the art should appreciate that solenoid 88 may be air core or iron core solenoid depending on the application. Solenoid 88 may be mounted in the chamber wall, in current holes for spark or glow plugs or fuel injectors, or in a new configuration in new engines.

### Method

FIG. 2 illustrates Lenz's law and the action of the ring when the solenoid 10 is given current 18. The ring 26 will push away. Applied magnetic fields 16 can be generated by various exemplary methods. For example, in one aspect of the present invention, a solenoid 82 is wrapped around the cylinder wall 78 as best illustrated in FIG. 7. In an alternative aspect of the present methods a solenoid 88 inside the cylinder 74 or in an existing porthole 72, used previously by spark plugs or fuel injectors, is disclosed. The solenoid 82, 88 may be electrically fed by distributor systems used in an existing engine to send voltage through spark plugs in gasoline engines or glow plugs in diesel engines. In either configuration, current generates magnetic flux or an applied magnetic field to drive the piston 42, 52 either into the solenoid 82, 88, or away, depending on the specific configuration. In the configuration shown in FIG. 7, the magnetic flux from solenoid 82 will pull the piston 42 toward the center of the solenoid 82. In the configuration shown in FIG. 8, the magnetic flux from the solenoid 88 travels through the hollow core 54 or middle of the ring formed by modified piston 42. The flux or applied magnetic field resulting from solenoid 82 produces a current in modified piston 42, and an induced magnetic field which opposes the applied magnetic field. Because opposite currents repel, the magnetic fields oppose each other and the piston 42 is pushed downward. The timing of repelling piston 42 can be electrically controlled by sequenced and/or ordered firing of solenoid 88 and pushing of respective pistons. Those skilled in this art can appreciate the steps and configuration needed to use timing systems of an existing engine to control firing of solenoids 82, 88. When current is removed from the solenoid 82, 88, the magnetic field instantly collapses to zero and the force on the piston is removed.

The present invention considers other aspects for controlling solenoid firing. For example, in one aspect, the present invention includes connecting the solenoid 82, 88 to an electronic controller (not shown) associated with the engine 80, 86, controlling electrical current from the electrical system associated with the engine 80, 86 to the solenoid 82, 88 to increase or decrease rpm of the engine 80, 86 with the electronic controller, connecting the solenoid 82, 88 to a resistor element (not shown) associated with an electrical system for operating the engine 80, 86, applying current to the solenoid 82, 88 includes applying current from a constant current source associated with the engine 80, 86, programming an electronic controller (not shown) associated with the engine 80, 86 to increase or decrease the rate of solenoid 82, 88 firing from the constant current source based on input from a throttle or accelerator associated with the engine 80, 86, controlling timing and firing of solenoid 82, 88 in each cylinder 74 with the electrical system for sequenced solenoid 82, 88 firing and ordered pushing and/or pulling on the crankshaft 76, and connecting the resistor element to a throttle or accelerator associated with the engine 80, 86 to change the current to the solenoid 82, 88 and rpm of the engine 80, 86. In another aspect, a resistor element, actuated by the acceleration pedal, which changes the amount of current going through the solenoid 82, 88, could be used. The change in current adjusts the force applied to the piston 42, 52 and controls engine 80, 86 speed.

FIG. 7 is a perspective cross sectional view of a modified pull-in diesel cylinder according to an exemplary embodiment of the present invention. FIG. 7 illustrates how solenoid 82 lines the cylinder wall 78. In a preferred form, solenoid 82 is wound to produce an upward magnetic field that will draw piston 42 up into the center of the solenoid 82. As is customary, engine block 84 provides the ground for the solenoid circuit. The voltage circuit associated with engine 80 connected to the solenoid 82 completes the circuit path. This circuit may be timed to produce a current when the piston 42 is at bottom dead center only or some other opportune position. The magnetic force from solenoid 82 pulls the piston 42 up to turn crankshaft 76.

FIG. 8 is a perspective sectional view of a modified push-out diesel cylinder according to an exemplary embodiment of the present invention. FIG. 8 best illustrates one possible placement of solenoid 88. One skilled in the art can appreciate that intake and exhaust valves are not necessary for operation. The engine block 100 provides the ground for the solenoid 88. The voltage circuit associate with the engine could be connected to solenoid 88 to complete the circuit. The voltage circuit could be timed to produce a current when the piston 52 is at top dead center, which creates a momentary jump in magnetic flux and an opposing magnetic field to drive the piston 52 away from the solenoid 88 and turn crankshaft 76.

Therefore apparatuses and methods for non-combustive driving a piston and turning a crankshaft have been disclosed. The present invention contemplates numerous variations, options, and alternatives and is not to be limited to the specific embodiment described herein.

What is claimed is:

1. A method for driving an engine without combustion, the method comprising:
providing an engine block with a plurality of cylinders formed by cylinder walls, a piston within each cylinder and a crankshaft connected to and driven by the piston;
placing a solenoid relative to each piston;
applying current to the solenoid to generate a magnetic flux; and
moving the piston relative to the position of the solenoid with magnetic flux from the solenoid to drive the crankshaft.

2. The method of claim 1 further comprising the step of wrapping the solenoid around the cylinder wall at an optimum location to affect movement of the piston.

3. The method of claim 2 further comprising the step of pulling the piston toward a center location of the solenoid using magnetic flux from the solenoid to drive the crank shaft.

4. The method of claim 3 further comprising the step of pushing the piston away from the center location of the solenoid using magnetic flux from the solenoid to drive the crank shaft.

5. The method of claim 1 further comprising the step of connecting the solenoid to an electronic controller associated with the engine.

6. The method of claim 5 further comprising the step of controlling electrical current from the electrical system associated with the engine to the solenoid to increase or decrease rpm of the engine with the electronic controller.

7. The method of claim 1 further comprising the step of connecting the solenoid to a resistor element associated with an electrical system for operating the engine.

8. The method of claim 1 wherein the applying current to the solenoid step includes applying current from a constant current source associated with the engine.

9. The method of claim 8 further comprising the step of programming an electronic controller associated with the engine to increase or decrease the rate of solenoid firing from the constant current source based on input from a throttle or accelerator associated with the engine.

10. The method of claim 5 further comprising the step of controlling timing and firing of solenoid in each piston with the electrical system for sequenced solenoid firing and ordered pushing and/or pulling on the crankshaft.

11. The method of claim 7 further comprising the step of connecting the resistor element to a throttle or accelerator associated with the engine to change the current to the solenoid and rpm of the engine.

12. The method of claim 1 wherein the piston is a ring having a hollow core.

13. The method of claim 12 further comprising the step of positioning the solenoid above the piston such that an applied magnetic field from the solenoid travels through the hollow core to produce an electrical current in the piston resulting in an induced magnetic field repelled by the applied magnetic field for driving the piston to turn the crank shaft.

14. The method of claim 12 further comprising the step of inserting the solenoid into a porthole in communication with the cylinder.

15. The method of claim 14 further comprising the step of passing an applied magnetic field from the solenoid through the hollow core to produce an electrical current in the piston resulting in an induced magnetic field repelled by the applied magnetic field for driving the piston downward to turn the crank shaft.

16. The method of claim 14 wherein the porthole is:
a. a hole for a glow plug;
b. a hole for a spark plug;
c. a hole for an injector;
d. a hold for a valve; or
e. any hole providing access into the cylinder.

17. A method for driving an engine without combustion, the method comprising:
providing an engine block with a plurality of cylinders formed by cylinder walls, a piston with a hollow core within each cylinder, a porthole into the cylinder, and a crank shaft connected to and driven by the piston;
placing a solenoid within the porthole;
applying current to the solenoid to generate an applied magnetic field;
creating an induced magnetic field in the piston by passing the applied magnetic field through the hollow core; and
repelling the piston to drive the crank shaft.

18. The method of claim 17 wherein the porthole is above the piston.

19. The method of claim 17 wherein the porthole is:
a. a hole for a glow plug;
b. a hole for a spark plug;
c. a hole for an injector;
d. a hold for a valve; or
e. any hole providing access into the cylinder.

20. An engine driven without combustion comprising:
an engine block having a plurality of cylinders formed by cylinder walls, a piston in each cylinder, and a crankshaft connected to and driven by the piston;
a solenoid positioned relative to each piston;
current from an electrical system associated with the engine applied to the solenoid to generate a magnetic flux; and
the piston moved flux relative to the position of the solenoid by the magnetic to drive the crankshaft.

21. The engine of claim 20 wherein the solenoid is wrapped around the cylinder wall at an optimum location to affect movement in the piston to drive the crankshaft.

22. The engine of claim 20 wherein a resistor element is connected to the electrical system, the resistor element adapted to control current from the electrical system to the solenoid to increase or decrease rpm of the engine.

23. The engine of claim 22 wherein the resistor element is connected to a throttle or accelerator associated with the engine to change the current to the solenoid and rpm of the engine.

24. The engine of claim 20 wherein the piston is a ring having a hollow core.

25. The engine of claim 24 wherein the solenoid is positioned above the piston such that an applied magnetic field from the solenoid travels through the hollow core to produce an electrical current in the piston resulting in an induced magnetic field repelled by the applied magnetic field to drive the piston downward and turn the crankshaft.

26. The engine of claim 20 wherein the engine further comprises a porthole in communication with the cylinder having a solenoid position therein.

27. The engine of claim 26 wherein an applied magnetic field from the solenoid passes through the hollow core to produce an electrical current in the piston resulting in an induced magnetic field repelled by the applied magnetic field for driving the piston downward to turn the crankshaft.

28. The engine of claim 27 wherein the porthole is:
a. a hole for a glow plug;
b. a hole for a spark plug;
c. a hole for an injector;
d. a hold for a valve; or
e. any hole providing access into the cylinder.

29. An engine driven without combustion comprising:
an engine block with a plurality of cylinders formed by cylinder walls, a piston with a hollow core disposed in each cylinder, a porthole into the cylinder, and a crankshaft connected to and driven by the piston;
a solenoid within the porthole;
an applied magnetic field generated by current applied to the solenoid;
an induced magnetic field generated in the piston by passing the applied magnetic field through the hollow core; and
the piston repelled away from the solenoid to move the crank shaft.

30. The engine of claim 29 wherein the porthole is above the piston.

31. The engine of claim 29 wherein the porthole is:
a. a hole for a glow plug;
b. a hole for a spark plug;
c. a hole for an injector;
d. a hold for a valve; or
e. any hole providing access into the cylinder.
